(19) United States
(12) Patent Application Publication
(10) Pub. No.: US 2023/0113356 A1
(43) Pub. Date: Apr. 13, 2023

(54) A METHOD AND SYSTEM FOR MAKING A SECURE PAYMENT

(71) Applicant: SNIIP LTD, Brisbane (AU)

(72) Inventors: Damien VASTA, Brisbane (AU); Alistair CORNISH, Brisbane (AU); David ADAMS, Brisbane (AU)

(73) Assignee: SNIIP LTD, Brisbane (AU)

(21) Appl. No.: 17/911,124

(22) PCT Filed: Mar. 12, 2021
(86) PCT No.: PCT/AU2021/050224

§ 371 Date: Sep. 12, 2022

(30) Foreign Application Priority Data
Mar. 12, 2020 (AU) 2020900752

(51) Int. Cl. G06Q 20/40

(52) U.S. Cl. CPC G06Q 20/401

(57) ABSTRACT

A method for making a secure payment, the method comprising the steps of: entering, using an online secure payment system, one or more pieces of information associated with a transaction for a customer from a biller; generating, via the online secure payment system, a digital bill for the customer from the one or more pieces of information; associating the digital bill with an account for the customer in the online secure payment system and alerting the customer to a change in status in the account; receiving, with the online secure payment system, a payment instruction for the digital bill from the customer; and processing, with the online secure payment system, the payment instruction for the digital bill and sending payment of the digital bill to the biller.

### TECHNICAL FIELD

The present invention relates to a method and system for making a secure payment. In particular, the invention relates, but is not limited to a method and system for making a secure payment of a digital bill using an online secure payment system.

### BACKGROUND ART

Online payment systems have become an increasingly popular way in which to pay for purchases, and especially online purchases. A variety of online payment systems exist, such as basic (and less secure) systems in which a user enters the details the details of a payment credential (such as a credit card) into an online form associated with a vendor.

More sophisticated systems exist, such as those in which a vendor provided issues an invoice with a unique payment code for a customer to enter into their online banking system. However, systems such as this suffer from a number of disadvantages, including a potential lack of online security or the possibility of fraudulent invoices being generated with fraudulent payment codes. In addition, the payment codes provided by a vendor are often long and complex, increasing the chance of a customer entering the wrong code into their payment system (such as an online banking system). This would, at best, delay payment or, at worst, transfer the payment to an incorrect account.

In addition to the disadvantages mentioned above, existing online payment systems are inconvenient to both customers and vendors in that the details of each bill that a customer received must be manually entered into a payment system. Not only does this increase the risk of entry errors, but it also makes it easy for a customer to forget to enter a bill into their payment system and makes it more difficult for customers to schedule payments in a manner that suits their financial situation. Not only is this inconvenient for the customer, but it can lead to delays in the vendor receiving payment which, particularly for small businesses, can significantly impact on their ability to conduct their business.

Thus, there would be an advantage if it were possible to provide an online secure payment system that not only increased the ease with which vendors and customers respectively send and receive bills, but assisted vendors in receiving payment more quickly than conventional systems.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method for making a secure payment, which may at least partially overcome at least one of the abovementioned disadvantages or provide the consumer with a useful or commercial choice.

With the foregoing in view, the present invention in one form, resides broadly in a method for making a secure payment, the method comprising the steps of:
(a) Entering, using an online secure payment system, one or more pieces of information associated with a transaction for a customer from a biller;
(b) Generating, via the online secure payment system, a digital bill for the customer from the one or more pieces of information;
(c) Associating the digital bill with an account for the customer in the online secure payment system and alerting the customer to a change in status in the account;
(d) Receiving, with the online secure payment system, a payment instruction for the digital bill from the customer; and
(e) Processing, with the online secure payment system, the payment instruction for the digital bill and sending payment of the digital bill to the biller

The online secure payment system may comprise any suitable processor. For instance, the processor may be a computing device, a group of connected computing devices, a server, a virtual server, a physical server, a computing cloud, a client terminal, a network node, a network server, a virtual machine, a personal electronic device, or the like. In an embodiment of the invention, the online secure payment system may comprise a cloud server. In an embodiment of the invention, the online secure payment system may comprise a modular program. In a preferred embodiment of the invention, the online secure payment system may be based on microservices architecture.

The method for making a secure payment comprises entering, using an online secure payment system, one or more pieces of information associated with a transaction for a customer from a biller. Any suitable user may enter one or more pieces of information into the online secure payment system. For instance, the user may be a customer, a biller, a third party, or any suitable combination thereof.

The user may be any suitable entity. For instance, the user may be an individual, a group of two or more individuals, a sole trader, a partnership, a corporate entity, a group of two or more corporate entities, a trust, a government agency, a charity, NGO, of the like. It is envisaged that a customer may be an entity that acquires goods or services from a biller or wishes to make payments to a biller. It is envisaged, that the biller may be an entity that provides goods or services to a customer or wishes to receive payments from a customer. It is envisaged, that the third party may be an entity that facilitates one or more transactions between a biller and a customer of the biller.

Preferably, however the user may be a registered user. In this instance, it is envisaged that registration of the user assists in managing security of the online secure payment system. Alternatively, the user may be required to input authentication information to authorise their access of the online secure payment system. In this instance, the user may use a PIN, a biometric reading, a face scan, a fingerprint scan, a password, an authorisation code, a one-time code, two factor authentication or the like, to access the online secure payment system.

In use, it is envisaged that different users may have different rights to access the online secure payment system. For instance, a biller may be able to enter one or more pieces of information into the online secure payment system to create a new bill, but may not be able to access customer payment details. For instance, a third party entering one or more pieces of information into the online secure payment system, on behalf of a biller, may be able to enter unique customer identifiers to create a bill, but may not be able to access customers' residential addresses. For instance, a customer may be able to search the online secure payment system for a biller name to identify existing transactions with a biller, but may not be able to display transactions for other customers of the biller. In this way, it is envisaged that the stored data may be stored securely and privacy of users maintained.

The biller may register to the online secure payment system in order to access the online secure payment system. Preferably, the biller has completed a Know Your Customer (KYC) or Customer Identification Program to verify the biller's identity. The biller may be required to input authentication information in order to access the online secure payment system. It is envisaged that in use, one or more features of the online secure payment system may only be accessible to a biller who has registered to the online secure payment system. For instance, ability to generate a digital bill may only be accessible to a biller who has input their authentication information into the system.

The transaction may be of any suitable type. For instance, the transaction may be for the purchase of one or more goods or services by a customer from a biller, a fee or fine owed to a biller by a customer, a donation to a biller by a customer, or the like. The one or more pieces of information may be associated with the transaction by any suitable means. For instance, the one or more pieces of information may identify and/or describe transaction details, biller details, customer details, payment details, or the like.

One or more pieces of information associated with a transaction for a customer may be entered into the online secure payment system. Any suitable information may be entered into the online secure payment system. However, it will be understood that the type of information entered may vary depending on a number of factors, such as the type of transaction, biller and customer, the purpose for entering the information into the online secure payment system and the type of information available to the user.

The one or more pieces of information associated with a transaction may be entered into the online secure payment system for any suitable purposes. For instance, to identify an existing bill, to add an existing bill, to create a new bill, and any suitable combination thereof.

In an embodiment of the invention, one or more pieces of information may be entered into the online secure payment system to assist a customer in identifying an existing bill with a biller. For instance, the customer may enter information such as a biller name, a unique biller identifier, a customer name, a unique customer identifier, or the like, into the online secure payment system. In this instance, it is envisaged that the customer may enter a search query into the online secure payment system so as to display one or more transactions.

In an embodiment of the invention, one or more pieces of information may be entered into the online secure payment system to assist a customer in adding an existing bill to the online secure payment system. For instance, the customer may enter information such as a hard copy bill, an electronic bill, an email bill, a barcode, a matrix barcode (such as a QR Code), a unique bill identifier, a unique biller identifier, or the like, into the online secure payment system. In this instance, it is envisaged that a customer may add an existing bill to the online secure payment system by acquiring (for example, by photographing, scanning, downloading, or the like) an electronic copy of at least a portion of the existing bill and then importing the electronic copy of the existing bill to the online secure payment system. Alternatively, a customer may add the existing bill to the online secure payment system by entering a unique identifier (such as a unique bill identifier, a unique biller identifier) into the online secure payment system. It is envisaged that in use, the online secure payment system may access one or more third party databases in order to relate the one or more pieces of information for a transaction with information contained within the one or more third party databases.

In an embodiment of the invention, one or more pieces of information may be entered into the online secure payment system to assist a biller, or a third party associated with the biller, to create a new bill for a transaction for a customer. For instance, the biller, or the third party associated with the biller, may enter information such as biller details, customer details, transaction details, payment details, or the like, into the online secure payment system. In an embodiment of the invention, a biller may enter one or more pieces of information associated with one or more transactions for a customer into the online secure payment system. In an alternative embodiment of the invention, a biller may enter one or more pieces of information associated with one or more transactions for two or more customers into the online secure payment system. In this way, a biller may create one or more bills for one or more customers.

The one or more pieces of information associated with a transaction may be entered into the online secure payment system by any suitable means. For instance, information may be entered into a register interface produced and displayed on an electronic device of the user, an application downloaded onto an electronic device of the user, through a bill generating program connected via an Application Programming Interface (API) to the online secure payment system, through a secure website or web portal associated with the online secure payment system, or the like. It is envisaged that, in use, the online secure payment system may be housed on a server and that a user may be able to gain access to the system through an internet connection whereby the user remotely accesses the online secure payment system. The electronic device may be of any suitable form. For instance, the electronic device may be a computer, mobile telephone, computing tablet, server, or the like.

The method for making a secure payment comprises generating, via the online secure payment system, a digital bill for the customer from the one or more pieces of information. The digital bill for the customer may be generated by any suitable means. For instance, a digital bill for a customer may be generated by transforming an imported electronic copy of an existing bill into a digital bill, reading a unique bill identifier on an existing bill with an imaging device and displaying the information as a digital bill, creating a digital bill directly from information entered by a user in the online secure payment system, or the like.

In an embodiment of the invention, a biller may generate one or more digital bills for one or more customers via the online secure payment system. In this instance, it is envisaged that the online secure payment system may enable a biller to generate digital bills in batch and/or bulk operations.

The method for making a secure payment comprises associating the digital bill with an account for the customer in the online secure payment system and alerting the customer to a change in status in the account. The account for the customer in the online secure payment system may be of any suitable type. Preferably, however, the account enables a customer to perform one or more functions such as receiving digital bills, storing digital bills, setting reminders to pay digital bills, scheduling payment of digital bills, storing payment information securely, making electronic payments of digital bills, storing transaction and payment history, or any suitable combination thereof.

A customer may use an account in the online secure payment system for any suitable transaction. For instance, the customer may use the account for making payment of a digital bill, for receiving payment of a digital bill (in this instance the customer may be a biller), for receiving a credit for a digital bill (in this instance, it is envisaged that the credit may be for a reversed payment, an overcharged amount, and the like), for receiving or depositing funds including cash deposits, or any suitable combination thereof.

The customer may register to the online secure payment system in order to access the online secure payment system. Preferably, the customer has completed a Know Your Customer (KYC) or Customer Identification Program to verify the customer's identity. The customer may be required to input authentication information in order to access the online secure payment system. It is envisaged that in use, one or more features of the online secure payment system may only be accessible to a customer who has registered to the online secure payment system. For instance, stored payment information and ability to make payments may only be accessible to a customer who has input their authentication information into the system.

The account for the customer in the online secure payment system may be associated with any suitable type of stored payment information for the customer. For instance, the stored payment information may be a digital wallet stored on an electronic device of the customer, a digital payment account, a credit or debit card of the customer, a financial institution, an exchange (such as cryptocurrency, foreign exchange), or the like. In an embodiment of the invention, the stored payment information may be associated with an account for the customer in the online secure payment system. In an embodiment of the invention, the stored payment information may be stored in the account for the customer in the online secure payment system. Preferably, the payment information may be securely stored. In this instance, it is envisaged that the stored payment information may be encrypted, may be accessible through inputting of authentication information, or the like.

The digital bill may be associated with an account for the customer in the online secure payment system by any suitable means. For instance, the digital bill and the customer account may be provided with a unique customer identifier which associates the digital bill with the customer account. Any suitable unique customer identifier may be used. For instance, the unique customer identifier may be personal information associated with the customer (such as an email address, name, phone number, or the like), may be a unique account number associated with the customer, may comprise de-identified data associated with the customer, or the like. In use, it is envisaged that associating the digital bill with the customer account may enable the customer to access the digital bill from the customer's account, may authenticate a customer as a valid receiver for a digital bill, or the like. In this way, it is envisaged that a customer may only receive valid digital bills and not receive fraudulent or incorrectly referenced digital bills.

In an embodiment of the invention, the digital bill is associated with the account for the customer on the online secure payment system by a unique identifier associated with the customer, wherein the digital bill is delivered to the account for the customer on the online secure payment system automatically. In a preferred embodiment of the invention, the online secure payment system enables automated digital bill delivery to the account for the customer using the unique identifier associated with the customer. Preferably, the digital bill is delivered to the account for the customer on the online secure payment system by a push notification. In this instance, it is will be understood that the online secure payment system may use a push notification to deliver the digital bill to the customer account.

It is envisaged that the digital bill may be delivered by a secure digital channel to an account for the customer on the online secure payment system. The customer may access the online secure payment system by any suitable means. For instance, the customer may access the online secure payment system through a register interface produced and displayed on an electronic device of the customer, an application downloaded onto an electronic device of the customer, through a secure website or web portal associated with the online secure payment system, or the like. It is envisaged that, in use, the online secure payment system may be housed on a server and that a customer may be able to gain access to the system through an internet connection whereby the customer remotely accesses the online secure payment system.

The customer may receive an alert to a change in status in the account for the customer in the online secure payment system. For instance, the customer may receive an alert to indicate a digital bill has been added to the account, a reminder that payment of a digital bill may be due and/or overdue, an alert that stored payment details may have expired, an alert that payment of a digital bill was successful, an alert that a credit or deposit of funds may have been received into the account, an alert that an unauthorised user may have accessed the account, an informative notification, a communication from the biller to the customer, or any suitable combination thereof. Any suitable type of alert may be issued. For instance, the alert may be a push notification, a visual indicator in a designated area or areas of the account, a pop-up window, a text message, an email message, or any suitable combination thereof.

The customer may delegate the digital bill to another customer account in the online secure payment system. In this instance, it is envisaged that the customer may delegate responsibility for payment of the digital bill to an accountant or finance officer in the customer's organisation.

The method for making a secure payment comprises receiving, with the online secure payment system, a payment instruction for the digital bill from the customer. Any suitable payment instruction may be received. For instance, the payment instruction may comprise identifying the stored payment information to pay the digital bill, instructing whether the digital bill may be partly paid, paid in full, or paid in instalments, scheduling the digital bill for payment at a later date, splitting the digital bill for payment between two or more customers, splitting the digital bill for payment between two or more types of stored payment information, not to pay the digital bill, request clarification of one or more items on the digital bill, or any suitable combination thereof.

The payment instruction for a digital bill may be received in any suitable manner. It is envisaged that the payment instruction from a customer may be delivered by a secure digital channel to the online secure payment system. For instance, the online secure payment system may receive the payment instruction through a register interface on an electronic device of the customer, an application downloaded onto an electronic device of the customer, through a secure website or web portal associated with the online secure payment system, or the like. In an embodiment of the invention, the payment instruction for the digital bill from the customer may be received by the online secure payment system in response to a push notification sent by the online secure payment system. Preferably, the payment instruction for the digital bill from the customer may be received by the online secure payment system in response to a push notification sent by the online secure payment system as a result of a digital bill being added to the account of the customer. In an embodiment of the invention, the payment instruction for the digital bill from the customer may be received by the online secure payment system in response to a scheduled payment. In a preferred embodiment of the invention, the online secure payment system receives a payment instruction for the digital bill from the customer by a push notification. In this instance, it will be understood that the customer may use a push notification to send payment instructions for the digital bill to the online secure payment system.

The method for making a secure payment comprises processing, with the online secure payment system, the payment instruction for the digital bill and sending payment of the digital bill to the biller. The payment instruction for a digital bill may processed in any suitable manner. For instance, the payment instruction may be sent to a payment processor for payment, may be processed with the online secure payment system, or any suitable combination thereof. However, it will be understood that the method of processing the payment instruction may vary depending on a number of factors, such as the type of payment instruction sent by the customer and the type of payment method accepted by the biller.

The payment instruction for the digital bill may be sent to any suitable payment processor. Preferably, however, the payment processor enables processing of a customer's stored payment information. For instance, the payment processor may include a digital payment solution such as an aggregated biller platform, a payment gateway for processing a credit or debit card of the customer, a financial institution, an exchange (such as cryptocurrency, foreign exchange), or the like. Preferably, the payment instruction may be delivered by a secure digital channel to a payment processor. Alternatively, the payment instruction for the digital bill may be processed directly by the online secure payment system. In this instance, the online secure payment system may act as a payment processor.

In an embodiment of the invention, one or more payment processors may be used for a process the payment instruction. For instance, if the payment instruction for a digital bill from a customer comprises a credit card payment to a biller that does not accept credit card payments, but does have an account with an aggregated biller platform, the credit card payment may be made into a trust account associated with the online secure payment system and when funds are cleared, a payment made into the biller's account on the aggregated biller platform via bank transfer. For instance, if the payment instruction for a digital bill from a customer comprises bank account details for a biller that has an account with an aggregated biller platform, the payment may be made directly by the online secure payment system to the biller via bank transfer.

The method for making a secure payment comprises sending payment of the digital bill to the biller. Any suitable means of sending payment of the digital bill to the biller may be used. However, it will be understood that means of sending payment to the biller may vary, depending on a number of factors, such as the type of payment processors involved to process the customer's payment instructions and the type of payment method accepted by the biller. The payment of the digital bill may be sent to the biller by any suitable entity. For instance, the entity may be a payment processor, the online secure payment system, a financial institution associated with the online secure payment system, a financial institution associated with the biller, or any suitable combination thereof.

In another aspect, the invention resides broadly in an online secure payment system for making a secure payment, the system comprising: at least at least one processor, at least one non-transitory computer readable storage medium storing instructions thereon that, when executed by the at least one processor, cause the system to:
a. Receive one or more pieces of information associated with a transaction for a customer from a biller;
b. Generate a digital bill for the customer from the one or more pieces of information;
c. Associate the digital bill with an account for the customer in the online secure payment system and alert the customer to a change in status in the account;
d. Receive a payment instruction for the digital bill from the customer; and
e. Process the payment instruction for the digital bill and send payment of the digital bill to the biller.

The present invention provides numerous advantages over the prior art. For instance, the present invention enables a connection between a customer and a biller which is secure and ensures the customer may only receive valid digital bills and not receive fraudulent or incorrectly referenced digital bills. In addition, the present invention provides users with the ability to receive and pay digital bills on a single system simplifies the bill payment process and eliminates the need for a user to move between two or more disparate systems. In addition, the system reduces the likelihood of a customer erroneously entering data during the bill payment process. Further, payment information entered by a customer may be securely stored and processed and the system allows a customer to pay using a bill using a payment type not accepted by the biller.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a schematic diagram of a method and system for making a secure payment according to an embodiment of the invention.

### DESCRIPTION OF EMBODIMENTS

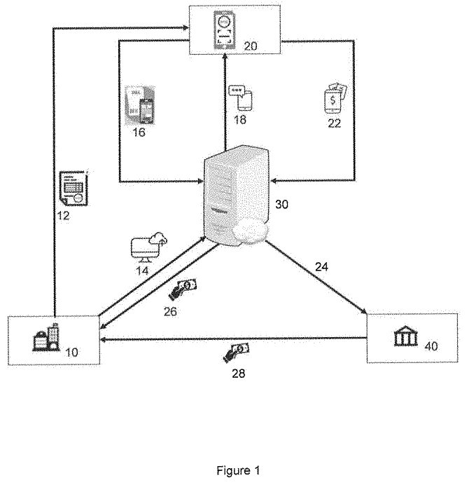

In FIG. 1, there is illustrated a schematic diagram of a method for making a secure payment. A biller 10, or a third party associated with the biller, enters one or more pieces of information associated with a transaction for a customer 20 into a bill generating program to create a bill 14 which is entered into the online secure payment system 30 via an interface. Alternatively, biller 10 emails or posts a bill 12 directly to customer 20 who scans at least a portion of the bill to form an electronic copy of the existing bill 16, which is entered into the online secure payment system 30 via an application downloaded to an electronic device of customer 20.

Online secure payment system 30 generates digital bill 18 for customer 20 which uses a unique customer identifier to associate digital bill 18 with the correct account of a customer 20 and delivers digital bill 18 to an account of customer 20 by a secure digital channel. Customer 20 receives a push notification alerting the customer that a digital bill has been added to their account. Customer 20 may access online secure payment system 30 by an application downloaded to an electronic device of customer 20 to view digital bill 18. Customer 20 sends payment instruction 22 for digital bill 18 using stored payment information securely stored in an account for customer 20 to the online secure payment system 30 by a secure digital channel.

Online secure payment system 30 receives payment instruction 22 from customer 20 for payment of digital bill 18 and sends payment instruction 24 to payment processor 40 for processing. Payment processor 40 processes payment instruction 24 and sends payment 28 of digital bill 18 to biller 10. Alternatively, payment instruction 22 is processed by the online secure payment system 30 directly and payment 26 of digital bill 18 is sent to biller 10.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for making a secure payment, the method comprising the steps of:
a. Entering, using an online secure payment system, one or more pieces of information associated with a transaction for a customer from a biller;
b. Generating, via the online secure payment system, a digital bill for the customer from the one or more pieces of information;
c. Associating the digital bill with an account for the customer in the online secure payment system and alerting the customer to a change in status in the account;
d. Receiving, with the online secure payment system, a payment instruction for the digital bill from the customer; and
e. Processing, with the online secure payment system, the payment instruction for the digital bill and sending payment of the digital bill to the biller.

2. A method for making a secure payment according to claim 1, wherein the customer and/or the biller is required to register to the online secure payment system before access to one or more features of the online secure payment system is granted.

3. A method for making a secure payment according to claim 1, wherein the customer and/or the biller is required to complete a customer identification program to verify the identity of the customer and/or the biller before access to one or more features of the online secure payment system is granted.

4. A method for making a secure payment according to claim 1, wherein stored payment information for the customer is associated with the account for the customer in the online secure payment system.

5. A method for making a secure payment according to claim 4, wherein the stored payment information for the customer is securely stored in the account for the customer in the online secure payment system.

6. A method for making a secure payment according to claim 1, wherein the one or more pieces of information associated with the transaction for the customer from the biller is entered into the online secure payment system through a bill generating program connected via an Application Programming interface (API) to the online secure payment system.

7. A method for making a secure payment according to claim 1, wherein the customer enters one or more pieces of information associated with the transaction for the customer from the biller into the online secure payment system by acquiring an electronic copy of at least a portion of a bill provided by a biller for the transaction and/or by entering a unique identifier associated with a bill provided by a biller for the transaction into the online secure payment system.

8. A method for making a secure payment according to claim 7, wherein the online secure payment system accesses one or more third party databases in order to relate the one or more pieces of information associated with the transaction for the customer for a biller with information contained within the one or more third party databases.

9. A method for making a secure payment according to claim 1, wherein the digital bill is associated with the account for the customer on the online secure payment system by a unique identifier associated with the customer.

10. A method for making a secure payment according to claim 1, wherein the digital bill is delivered to the account for the customer on the online secure payment system automatically.

11. A method for making a secure payment according to claim 9, wherein the online secure payment system enables automated digital bill delivery to the account for the customer using the unique identifier associated with the customer.

12. A method for making a secure payment according to claims 1, wherein the digital bill is delivered to the account for the customer on the online secure payment system by a push notification.

13. A method for making a secure payment according to claim 1, wherein the online secure payment system receives a payment instruction for the digital bill from the customer by a push notification.

14. An online secure payment system for making a secure payment, the system comprising: at least at least one processor, at least one non-transitory computer readable storage medium storing instructions thereon that, when executed by the at least one processor, cause the system to:
a. Receive one or more pieces of information associated with a transaction for a customer from a biller;
b. Generate a digital bill for the customer from the one or more pieces of information;
c. Associate the digital bill with an account for the customer in the online secure payment system and alert the customer to a change in status in the account;
d. Receive a payment instruction for the digital bill from the customer; and
e. Process the payment instruction for the digital bill and send payment of the digital bill to the biller.

15. An online secure payment system for making a secure payment according to claim 14, wherein the one or more pieces of information associated with the transaction for the customer from the biller is received by the online secure payment system through a bill generating program connected via an Application Programming Interface (API) to the online secure payment system.

16. An online secure payment system for making a secure payment according to claim 14, wherein the one or more pieces of information associated with the transaction for the customer from the biller is received by the online secure payment system by acquiring an electronic copy of at least a portion of a bill provided by a biller for the transaction and/or by entering a unique identifier associated with a bill provided by a biller for the transaction into the online secure payment system.

17. An online secure payment system for making a secure payment according to claim 16, wherein the online secure payment system accesses one or more third party databases in order to relate the one or more pieces of information associated with the transaction for the customer for the biller with information contained within the one or more third party databases.

18. An online secure payment system for making a secure payment according to claim 14, wherein the digital bill is associated with the account for the customer on the online secure payment system by a unique identifier associated with the customer.

19. An online secure payment system for making a secure payment according to claim 14, wherein the digital bill is delivered to the account for the customer on the online secure payment system automatically.

20. An online secure payment system for making a secure payment according to claim 18, wherein the online secure payment system enables automated digital bill delivery to the account for the customer using the unique identifier associated with the customer.

21. An online secure payment system for making a secure payment according to claim 14, wherein the digital bill is delivered to the account for the customer on the online secure payment system by a push notification.

22. An online secure payment system for making a secure payment according to claim 14, wherein the online secure payment system receives a payment instruction for the digital bill from the customer by a push notification.

23. An online secure payment system for making a secure payment according to claim 14 wherein processing the payment instruction for the digital bill involves inputting authentication information to access stored payment information for the customer.
